(19) United States
(12) Patent Application Publication
(10) Pub. No.: US 2022/0260054 A1
(43) Pub. Date: Aug. 18, 2022

(54) METHOD FOR CONTROLLING A WIND FARM, CONTROL MODULE FOR A WIND FARM, AND WIND FARM

(71) Applicant: POLYTECH WIND POWER TECHNOLOGY GERMANY GMBH, München (DE)

(72) Inventor: Luis VERA-TUDELA, München (DE)

(21) Appl. No.: 17/627,745

(22) PCT Filed: Jul. 1, 2020
(86) PCT No.: PCT/EP2020/068507

§ 371 Date: Jan. 17, 2022

(30) Foreign Application Priority Data
Jul. 22, 2019 (DE) 10 2019 119 774.0

(51) Int. Cl. F03D 7/04; F03D 17/00

(52) U.S. Cl. CPC F03D 7/048; F03D 17/00; F05B 2270/335; F05B 2260/821; F05B 2270/321; F05B 2270/32; F05B 2270/331

(57) ABSTRACT

A method (300) for the control of a wind farm (10) is disclosed. The method (300) comprises: read-in of data from at least one first wind power plant (200) of the wind farm; supply of the read-in data from the at least one first wind power plant to a statistical prediction model for the control of at least one second wind power plant (200) of the wind farm based on the read-in data from the at least one first wind power plant; and use of the statistical prediction model to control the at least one second wind power plant (200).

### TECHNICAL FIELD

Forms of embodiment of the present disclosure relate to a method for the control of a wind farm, a control module, and a wind farm. In particular, forms of embodiment of the present disclosure relate to a method for the control of a wind farm, a control module, and a wind farm, which method, with the inclusion of a statistical prediction model can control at least one second wind power plant on the basis of data from a first wind power plant.

### PRIOR ART

Wind power prediction can be relevant in order to ensure the right balance between energy delivery capability and energy demand. Historically, the development of the prediction has been limited to a macroscopic level, with a focus on regions, portfolios and wind farms.

Here physical (weather) models have predominantly been used to provide a prediction of the wind power. Physical models estimate an “actual” wind speed upstream of the rotor of a wind power plant, on the basis of measurements that have been obtained by means of sodar, lidar, radar, etc., or corrected data from anemometers arranged on the nacelle. Here, each measurement approach aims to look upstream of the wind power plant(s) of interest. Statistical corrections for the prediction are typically based on data sets of weather conditions at a farm-level.

At the same time, the market is maturing, and is moving away from a pure compensation for electricity fed into the grid towards a more flexible open market. This is accompanied by other requirements for the development of wind power prediction. For example, shorter prediction windows are needed, which also depend on statistical approaches, and not on (physical) weather models.

### SUMMARY OF THE INVENTION

Forms of embodiment of the present disclosure provide methods for the control of a wind farm. Furthermore, forms of embodiment of the present disclosure provide a control module for a wind farm. Furthermore, forms of embodiment of the present disclosure provide a wind farm.

In accordance with one form of embodiment, a method for the control of a wind farm is provided. The method comprises: read-in of data from at least one first wind power plant of the wind farm; supply of the read-in data from the at least one first wind power plant to a statistical prediction model for the control of at least one second wind power plant of the wind farm on the basis of the read-in data from the at least one first wind power plant; and use of the statistical prediction model to control the at least one second wind power plant.

In accordance with one form of embodiment, a control module for a wind farm is provided. The control module is configured to execute a method for the control of a wind farm. The method comprises: read-in of data from at least one first wind power plant of the wind farm; supply of the read-in data from the at least one first wind power plant to a statistical prediction model for the control of at least one second wind power plant of the wind farm based on the read-in data from the at least one first wind power plant; and use of the statistical prediction model to control the at least one second wind power plant.

In accordance with one form of embodiment, a wind farm is provided. The wind farm comprises: at least one first wind power plant; at least one second wind power plant; and a control module for the control of the at least one first and/or second wind power plant. The control module is configured to execute a method for the control of a wind farm. The method comprises: read-in of data from at least one first wind power plant of the wind farm; supply of the read-in data from the at least one first wind power plant to a statistical prediction model for the control of at least one second wind power plant of the wind farm based on the read-in data from the at least one first wind power plant; and use of the statistical prediction model to control the at least one second wind power plant.

### BRIEF DESCRIPTION OF THE DRAWINGS

Examples of embodiment are illustrated in the drawings and explained in more detail in the following description. In the drawings:

FIG. 1 shows schematically an example of a wind farm with three wind power plants in accordance with forms of embodiment described herein;

FIG. 2 shows schematically a wind power plant in accordance with forms of embodiment described herein;

FIG. 3 shows a flow chart of a method in accordance with forms of embodiment described herein; and

FIG. 4 shows schematically an example of a wind farm with four wind power plants in accordance with forms of embodiment described herein;

In the drawings, the same reference symbols denote the same, or functionally identical, components or steps.

### PATHS TO THE EMBODIMENT OF THE INVENTION

In what follows, more detailed reference is made to various forms of embodiment of the invention, wherein one or a plurality of examples are illustrated in the drawings.

As established above, the prediction windows are becoming ever smaller. Wind power prediction models with a 5 to 10 minute prediction window would be desirable. At this level, it is assumed that high-frequency signals that describe a wind-to-power interaction will dominate the spectrum of variables required for purposes of prediction. Moreover, loads have not previously been considered as prediction parameters, in particular because systems for continuous monitoring have been lacking.

The present disclosure can provide a prediction of wind energy across the turbines, and, if required, also of mechanical loadings. In particular, the present disclosure can provide a statistical prediction model that can be used for the control of a wind farm, and that enables an optimised control of at least one additional wind power plant, up to the entire wind farm, on the basis of the data from one wind power plant.

In particular, the energy demand can also be used as an optimisation variable, in order to ensure an efficient utilisation of the wind farm. Individual wind power plants can, for example, be taken out of service when energy demand is low, or operated with overload when energy demand is high.

In particular, a measurement system can be provided that records mechanical loads and/or electrical power from at least one wind power plant in a wind farm at a high sampling rate, in order to be able to make a turbine-to-turbine prediction. The mechanical loadings in the blades can be recorded by sensors (using fibre optic or other technology), and the electrical power can be recorded by a SCADA system. Additionally or alternatively, the mechanical loadings and/or the electrical power can be estimated with data that has been recorded by sensors in the rotor blades, and statistical models. Depending on the separation of the turbines, the wind direction, and the wind speed, high-frequency data from neighbouring turbines can be used to make predictions of the electrical power and the mechanical loading approximately 1-3 minutes in advance. In particular, the prediction time can depend on the average wind speed and the separation between two installations (Taylor Hypothesis). This can take place, for example, in a data processing unit. With the present disclosure, for example, the prediction of the electrical power and the mechanical loadings on the first turbine in the wind direction can be based only on a combination of historical data and numerical weather prediction models, whereas all the other turbines can be controlled on the basis of the data from the first (and also other) turbines.

Thus the prediction of the electrical power and the mechanical loadings or stresses for all the other turbines can be based on a combination of historical data and real-time measurements.

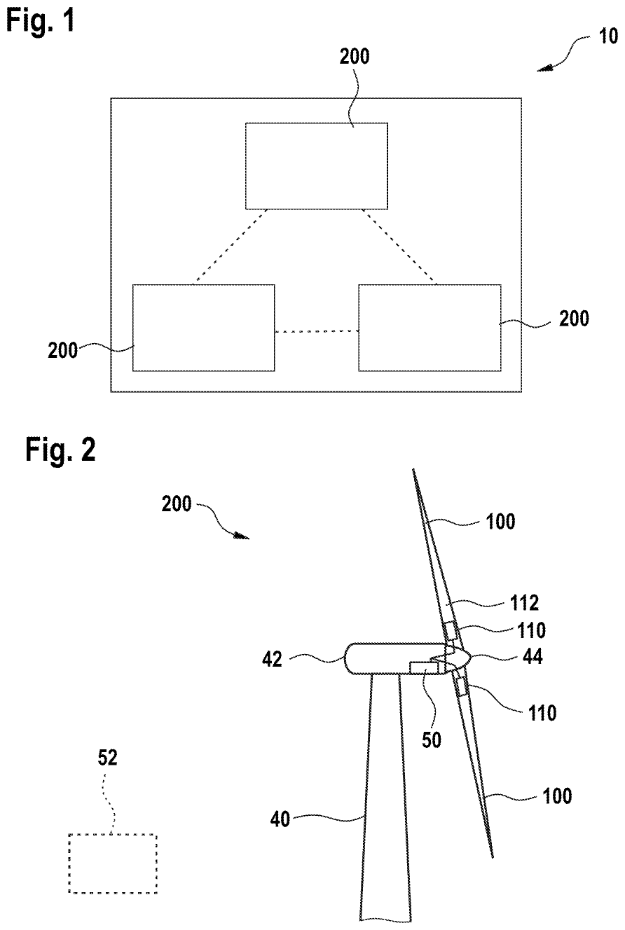

FIG. 1 shows an example of a wind farm 10 with three wind power plants 200. The wind power plants 200 are interconnected, as shown by the dashed lines in FIG. 1. The interconnection enables a communication, for example a real-time communication, between the individual wind power plants. The interconnection furthermore enables a common monitoring, control, and/or regulation, of the wind power plants. In addition, the wind power plants can also be monitored, controlled and/or regulated individually. In accordance with the forms of embodiment described here, a wind farm can contain two or more wind power plants, in particular five or more wind power plants, for example, ten or more wind power plants.

The wind power plants 200, for example the wind power plants of FIG. 1, in their entirety form the wind farm 10. The wind farm comprises at least two wind power plants, which are spatially arranged at a separation distance from each other.

FIG. 2 shows an example of a wind power plant 200 of a wind farm, on which the method described herein can be used. The wind power plant 200 includes a tower 40 and a nacelle 42. The rotor is attached to the nacelle 42. The rotor includes a hub 44, to which the rotor blades 100 are attached. In typical forms of embodiment, the rotor has at least two rotor blades, more particularly, three rotor blades. During operation of the wind power plant, the rotor, that is to say, the hub with the rotor blades, rotates about an axis. In so doing, a generator is driven to produce electricity. As illustrated in FIG. 2, at least one sensor 110 is provided on a rotor blade 100. The sensor 110 can be connected to an interface 50 by way of a signal line. The interface 50 can provide a signal to a control and evaluation unit 52 of the wind power plant 200. In particular, the interface 50 can be a SCADA (supervisory control and data acquisition) interface.

In accordance with forms of embodiment described herein, the wind power plant 200 can comprise a control module 52. In particular, the control module 52 serves to control and/or regulate, and/or interrogate, the interface 50, that is to say the sensor 110, and the wind power plant. The control module 52 can, for example, control and/or regulate the SCADA interface, and/or transfer data between the SCADA interface and the control module 52. The control module 52 can communicate with the interface 50. The control module 52 can be hardwired, or wirelessly connected, to the interface 50.

The control module 52 can contain a computer program product that can be loaded into a memory of a digital computing device, and that includes software code segments that can be used to execute steps in accordance with one or a plurality of the other aspects, when the computer program product is running on the computing device. Furthermore, a computer program product is proposed that can be loaded directly into a memory, for example, a digital memory of a digital computing device. In addition to one or a plurality of memories, a computing device can contain a CPU, signal inputs and signal outputs, together with other elements typical of a computing device. A computing device can be part of an evaluation unit, or the evaluation unit can be part of a computing device. A computer program product can include software code segments with which the steps of the methods of the forms of embodiment described herein are executed, at least in part, when the computer program product is running on the computing device. In this regard, any forms of embodiment of the method can be executed by a computer program product.

The sensor 110 can, in particular, be a mechanical load sensor. For example, each rotor blade of the wind power plant can comprise a sensor. The sensor can, in particular, be an acceleration sensor, a vibration sensor, and/or a strain sensor. Furthermore, the sensor can be an electrical sensor or a fibre optic sensor. Furthermore, the sensor can also be provided on other components of the wind power plant 200, such as the tower 40, the nacelle 42, the generator, etc. The sensor 110 can also measure a fatigue loading. Furthermore, a wind power plant 200 can also be equipped with a plurality of sensors to measure, in parallel, data from a plurality of components, and/or other types of data from the same component.

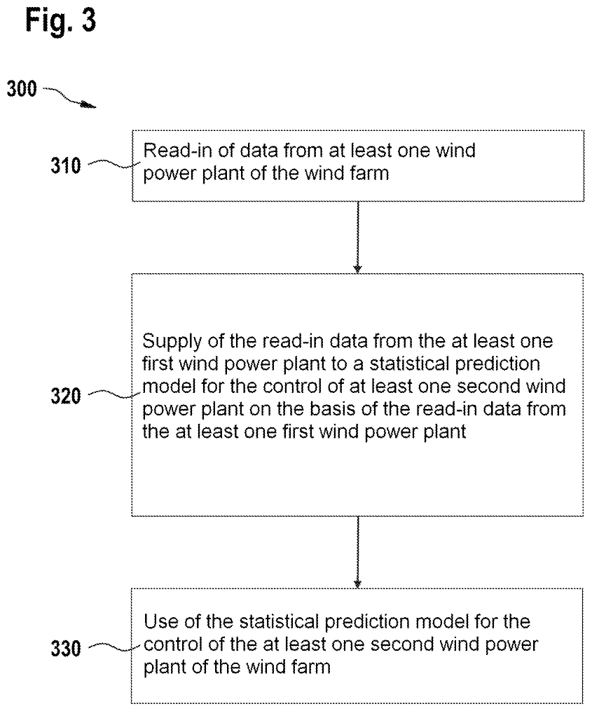

FIG. 3 illustrates a flowchart of a method 300 for the control of a wind farm 10 in accordance with forms of embodiment described herein.

In accordance with one block 310, data can be read in from at least one first wind power plant 200 of the wind farm 10.

In accordance with one block 320, the read-in data from the at least one first wind power plant 200 can be supplied to a statistical prediction model for the control of at least one second wind power plant 200 of the wind farm 10, based on the read-in data from the at least one first wind power plant.

In accordance with one block 320, the statistical prediction model can be used to control the at least one second wind power plant 200.

In practice, a near-term wind power and load prediction can be created, based on a static model. In particular, additional information can be obtained by means of a high sampling rate. In particular, by measurement and prediction of a mechanical loading on the rotor blades, a performance optimisation can be provided, with which, for example, the operation of wind power plants on the basis of an energy demand can be improved.

In practice, by means of the method in accordance with forms of embodiment described herein, wind power plants can be operated no longer purely as passive systems, but can be used as active measurement systems that deliver validated information. Here, the higher the number of wind power plants in a wind farm, the higher can be the number of system validations for an electrical power and/or mechanical loading. Hybrid models, that is to say, models that incorporate a physical prediction model in addition to a static prediction model, can further improve the accuracy of weather prediction models at the level of individual wind power plants, and at very short time intervals. In particular, this can be a Bayesian system of continuous learning that evolves and improves the system in the course of time. In particular, the method disclosed here can in practice be used to create an optimisation based on the energy demand, the mechanical loading, and a performance prediction.

In accordance with forms of embodiment described herein, the read-in data can comprise at least electrical performance data and/or mechanical load data. The electrical performance data can be read in by way of a SCADA system. Additionally or alternatively, the mechanical loadings and/or the electrical power can be estimated using data that has been recorded with sensors in the rotor blades, and statistical models. For example, the mechanical load data can be read in by way of the sensor 110, or a plurality of sensors 110. Additionally or alternatively, the mechanical loadings can also be estimated from models that have been created on another wind power plant of the same type, and which in particular connect the SCADA system and/or the sensor 110.

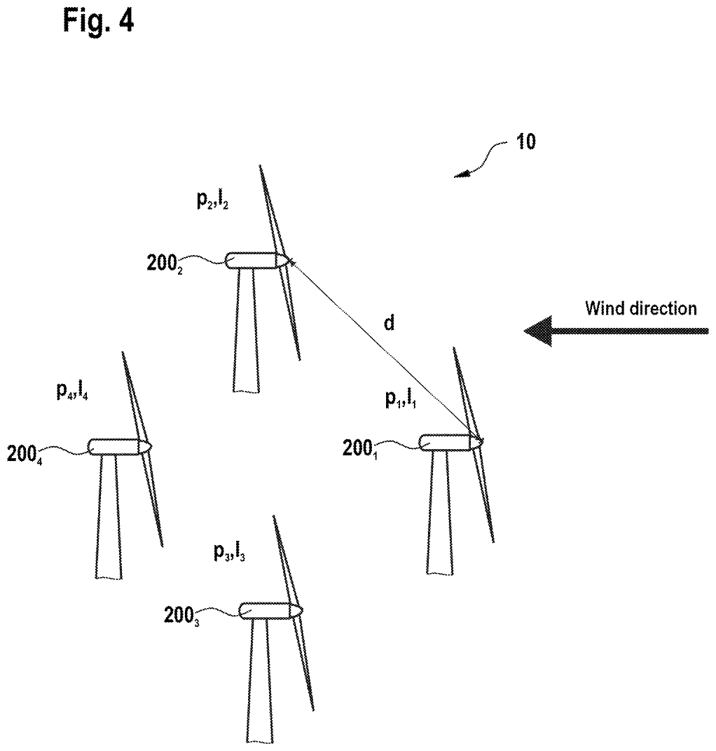

FIG. 4 shows a wind farm 10 in accordance with forms of embodiment described herein. The wind farm 10 is illustrated in an exemplary manner with a first wind power plant 2001, a second wind power plant 2002, a third wind power plant 2003, and a fourth wind power plant 2004. However, the wind farm 10 can have any other number of wind power plants.

The wind power plants 2001 to 2004 are shown with respective mechanical load values l₁ to l₄, and respective electrical power values p₁ to p₄. Here, these values, in particular the respective mechanical load values l₁ to l₄, can also represent a set of values comprising a plurality of values. For example, a respective mechanical load value p_{1,i} to p_{4,i} can be provided for each sensor 110ᵢ. The electrical power values pᵢ and the mechanical load values lᵢ can form the electrical power data and the mechanical load data, respectively.

In accordance with forms of embodiment described herein, the electrical power value pj and the mechanical load value lⱼ of the jth wind power plant 200ⱼ can be obtained as a first function f from the weather model, and the electrical power value pj and the mechanical load value lⱼ. The electrical power value p_{i>j} and the mechanical load value l_{i>j} of the i>jth wind power plants 200_{i>j} can be obtained as a second function g from the weather model, and the electrical power value p_{i>j} and the mechanical load value l_{i>j}. In accordance with forms of embodiment described herein, the statistical prediction model can make predictions for an electrical power and/or mechanical load to be anticipated for the at least one second wind power plant.

In particular, different models can be differentiated on the basis of their individual priorities: a machine learning model can be dominated by statistics in the short term; a weather model can be dominated by weather fronts in the medium to long term. Weather models are already used for longer time horizons. The present disclosure can fill the gap for short-term predictions, in particular by means of a combination of weather models with statistics, or simply by means of statistics (machine learning models).

In particular, the present disclosure can provide the option of combining known physical relationships together with direct measurements in a hybrid model, so as to improve predictions continuously over time.

In FIG. 4, a distance d between the first wind power plant 2001 and the second wind power plant 2002 is delineated in an exemplary manner. A corresponding distance exists, of course, between each pair of wind power plants. In accordance with forms of embodiment described herein, the statistical prediction model can take into account a distance d between the at least one first wind power plant 200₁ and the at least one second wind power plant 200₂, a wind direction, and/or a wind speed.

In practice, after installation, the system measures setpoint values of e.g. power and mechanical loadings, in addition to other variables such as weather, SCADA, energy demand, etc. A physical model is created, a priori, in order to estimate roughly the target variables. However, the system or method, in accordance with forms of embodiment, can continuously select the most relevant variables in order to predict a target value for each of the wind power plants (p₁, l₁, p₂, l₂, p₃, l₃, etc.) and can correct its selection and its model over time (in particular by way of a Bayesian approach to continuous learning). In practice, it may be that it is not necessary explicitly to correct the physical measurements, since the system can statistically correct the predictions and thus form a hybrid model.

In overall terms, all parameters can be used that contain statistical information for the prediction, that is to say, information that is statistically significant. Here, wind direction and speed can be good parameters, but a corrective calibration is usually required, which can lead to increased effort.

In accordance with forms of embodiment described herein, the statistical prediction model can comprise a machine learning method. By this means the model can adapt itself to the particular environment and the layout of the wind farm 10.

In accordance with forms of embodiment described herein, the statistical prediction model can use data from at least two first wind power plants to control the at least one second wind power plant. This can further improve the prediction. The prediction for the second wind power plant can also, for example, be provided by data from all the other wind power plants.

In accordance with forms of embodiment described herein, the data can be read in at a high sampling rate of 1 Hz or more. The data can also be read in at different sampling rates. For example, the electrical power can be read in at a rate of at least 1 Hz and/or the mechanical loading can be read in at a rate of at least 10 Hz.

In accordance with forms of embodiment described herein, the control of the at least one second wind power plant 2002 in accordance with the statistical prediction model can comprise a control of an angle of attack of a blade of the at least one second wind power plant 2002, a control of a torque of the at least one second wind power plant 2002, a damping system in a tower structure of the at least one second wind power plant 2002, and/or active mechanisms in a blade control system (active tip, twist, flap, etc.) of the at least one second wind power plant 2002.

In accordance with forms of embodiment described herein, external data from meteorological sensors can be read in, and supplied to the statistical prediction model. This can further increase the accuracy.

In accordance with forms of embodiment described herein, data can be supplied to a physical prediction model in order to control the at least one second wind power plant (200). This can result in a hybrid model made up from the statistical prediction model and a physical prediction model. This can further increase the accuracy.

In accordance with forms of embodiment described herein, the control module 52 can be configured so as to execute some, many, or all, of the operations of the method 300 described herein.

In accordance with forms of embodiment described herein, a wind farm 10 can have such a configured control module 52 in order to control at least one first wind power plant 200 and/or second wind power plant 200. In particular, the second wind power plant 200 can be controlled in accordance with the method 300.

Although the present invention has been described above with reference to typical examples of forms of embodiment, it is not limited to these, but rather can be modified in a variety of ways. Neither is the invention limited to the possible applications cited. At this point it should also be noted that the aspects and forms of embodiment described herein can be combined appropriately with one another, and that individual aspects can be omitted where it is reasonable and possible within the scope of the activities of the person skilled in the art. Variations and additions to the aspects described herein will be familiar to the person skilled in the art.

1. Method for the control of a wind farm, comprising:
Read-in of data from at least one first wind power plant of the wind farm;
Supply of the read-in data of the at least one first wind power plant to a statistical prediction model for the control of at least one second wind power plant of the wind farm, on the basis of the read-in data of the at least one first wind power plant; and
Use of the statistical prediction model to control the at least one second wind power plant.

2. Method according to claim 1, wherein
read-in data comprises at least electrical power data, and/or mechanical load data.

3. Method according to claim 2, wherein
the electrical power data is read in by way of a SCADA system, and/or the mechanical load data is read in by way of at least one sensor.

4. Method according to claim 1, wherein
the statistical prediction model takes into account a distance (d) between the at least one first wind power plant and the at least one second wind power plant, a wind direction, and/or a wind speed.

5. Method according to claim 1, wherein
the statistical prediction model has a machine learning method.

6. Method according to claim 1, wherein
the statistical prediction model uses data from at least two first wind power plants to control the at least one second wind power plant.

7. Method according claim 1, wherein
the data is read in at a high sampling rate of 1 Hz or more.

8. Method claim 1, wherein
the statistical prediction model makes predictions for an electrical power and/or mechanical load to be anticipated for the at least one second wind power plant.

9. Method according claim 1, wherein
in accordance with the statistical prediction model the control of the at least one second wind power plant (200) comprises a control of an angle of attack of a blade of the at least one second wind power plant (200), a control of a torque of the at least one second wind power plant (200), a damping system in a tower structure of the at least one second wind power plant (200), and/or active mechanisms in a blade control system of the at least one second wind power plant (200).

10. Method according claim 1, wherein
furthermore, external data from meteorological sensors is read in and supplied to the statistical prediction model, which in particular can be a Bayesian hybrid model that learns continuously and improves its predictions over time.

11. Method according claim 1, wherein
furthermore, data is supplied to a physical prediction model in order to control the at least one second wind power plant, which in particular can be a Bayesian hybrid model that learns continuously and improves its predictions over time.

12. A control module for a wind farm, which is configured to execute the method according to claim 1.

13. Wind farm, comprising:
at least one first wind power plant;
at least one second wind power plant; and
a control module according to claim 12 for the control of the at least one first and/or second wind power plant.
